(19) United States
(12) Patent Application Publication
(10) Pub. No.: US 2013/0098182 A1
(43) Pub. Date: Apr. 25, 2013

(54) DEVICE FOR THE TRANSMISSION OF TORQUE FROM A DRIVING SHAFT TO A DRIVEN SHAFT

(71) Applicant: Valeriy Borovskikh, Moscow (RU)

(72) Inventor: Valeriy Borovskikh, Moscow (RU)

(21) Appl. No.: 13/635,673

(22) PCT Filed: Mar. 18, 2011
(86) PCT No.: PCT/RU2011/000168

§ 371 Date: Sep. 17, 2012

(30) Foreign Application Priority Data
Mar. 25, 2010 (RU) 2010111265

(51) Int. Cl. F16H 21/12

(52) U.S. Cl. CPC F16H 21/12
USPC 74/67

(57) ABSTRACT

The invention relates to the field of mechanical engineering and is designed to transmit torque from a driving shaft to a driven shaft. The device consists of eccentrics, secured in a number of not less than three to each of the shafts, and cable-type connecting rods. The eccentrics may be mounted at equal intervals or, in order to reduce vibrations, offset by up to 50 degrees of angular rotation. The cable-type connecting rods connect via bearings the eccentrics of the driving and driven shafts and operate solely in tension. The use of cable-type connecting rods makes it possible to increase the specific loads, which leads to a reduction in weight of the connecting rods and counterweights. From four to twelve eccentrics are secured to each of the shafts in order to increase the uniformity of torque transmission to the driven shaft.

### FIELD OF THE INVENTION

The invention relates to the field of mechanical engineering. Presently, transmission of torque between parallel drive shafts and driven shafts positioned at a distance of one to several meters from each other is achieved by means of a transmission shaft, which is installed, as a rule, perpendicularly to them and connected to each of them through angular gearboxes. The fact that the torque changes direction twice decreases the efficiency coefficient of the device, especially if the gears of the angular gearboxes are of the hypoid type, for which the teeth of the gears roll with slippage. The method, popular in the design of steam locomotives, is never used.

### PRIOR ART

The drive wheel of a locomotive, powered by a connecting rod from the piston of the steam engine, is connected with a coupling rod to the other wheel and thereby sends torque to a parallel shaft. One of the reasons why the transfer of torque using connecting rods fails in modern vehicles is the weight of the connecting rods, which grows proportionally to the distance between the shafts. Use of connecting rods leads to creation of unbalanced forces which vary in strength and direction, requiring the use of counterweights, which significantly increase the weight of the vehicle. This is apparent from the study of locomotive drive wheels design. On the side with connecting rods, the axle with the rim of the wheel is connected by spokes, and on the other side by cast disk.

### DISCLOSURE OF THE INVENTION

The invention seeks to reduce the negative aspects of using connecting rods.

A prototype of this design can be found in patent: U.S. Pat. No. 2,203,975 (A)—1940 Jun. 11 (ipc B61C 9/04; B61C9/00). In order to balance the torque, for two drive wheel pairs, axles are implemented as crankshafts with three cranks offset by 120 degrees, with the cranks connected by connecting rods.

Placement of cranks every 120 degrees allows consistent transmission of torque. During the transmission of torque by one or two connecting rods there exist points, for which the torque equals zero, which is usually undesirable. The prototype describes crankshafts, but eccentrics with eccentricity equal to that of the crank can replace crankshafts, or be used together is the need arises. In MPK F16C 3/04 one can find description of crankshafts, shafts with eccentrics, cranks, eccentrics, so some of their characteristics and functionality are grouped together. From here on, when describing the workings of eccentrics we also assume they are applicable to cranks (crankshafts) and vice versa.

Currently, connecting rods experience alternating forces. They are manufactured from steel alloys with a specific strength up to 100 kg/mm2, which is close to the maximum strength for this material. It should be noted that there exist steel parts, designed for operation in tension, with specific strength of 200 kg/mm2—namely steel cable wires.

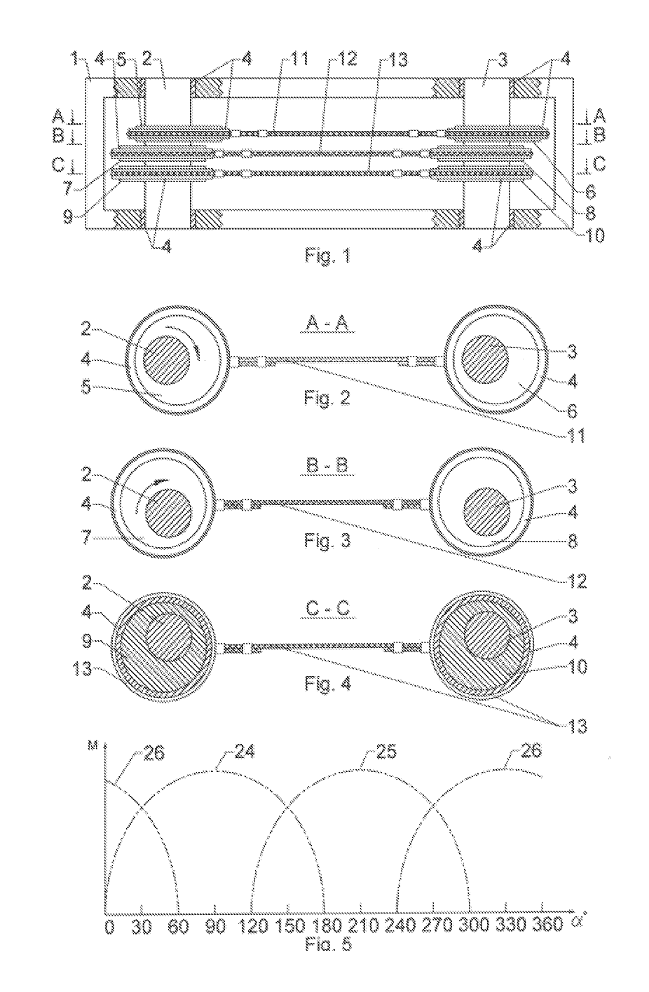

We propose increasing specific loads, by replacing rigid connecting rods with flexible cables (FIG. 1). For this design to work, three eccentrics are used on the drive shaft and three eccentrics are mounted on the driven shaft with 120 degree offset from each other (FIGS. 1,2,3, and 4).

By using steel cables as connecting rods it is possible to halve the weight of the connecting rods and counterweights. Common practice includes using cables from aramid fibers (Kevlar—brand name marketed by the firm DuPont http://www.chinaprice.ru/sell/n4c7c26718f22b1, Armos and Rusar—Russian analogs http://www.aramid.ru).

Aramid fibers have specific strength up to 450 kg/mm2, specific weight being 1.45 g/cm3. This is 5.38 times less than the specific weight of steel. Using aramid cables as connecting rod allows a 24-fold weight reduction of connecting rods and counterweights.

Cables working only for tension, are able to transfer torque only during 180 degree turn of the shaft. By positioning second and third eccentrics at 120 degree offset it is possible to create overlap so that the second eccentric starts pulling well before the completion of the first eccentrics pulling motion and the same holds true for the second and third eccentrics. This provides constant torque transfer to the driven shaft during its complete rotation. Eccentric pulling actions overlap by 60 degrees. FIG. 5 shows the torque as a function of the driven shaft's angular rotation. Such torque fluctuation can, in some cases, increase vibration of the mechanism and even destroy the device during resonance. Vibration, induced by connecting rods, can be lowered by way angular offset of one or two eccentrics on the drive shaft and corresponding eccentrics on the driven shaft. This offset has to be less than the pulling motion's 60 degree overlap. From this follows that combined angular offset shouldn't exceed 50 degrees.

In order to decrease torque fluctuations of the driven shaft it is desirable to use more than three eccentrics. For high-torque transfers, twelve eccentrics should be sufficient. As cables work during only half of the rotation, twelve cables will do the work of six regular connecting rods. The balance of six connecting rods in a six cylinder internal combustion engine is considered optimal and this design is widely used despite the greater complexity of angular torque variance on the connecting rods compared to our cable-type connecting rod design. When using twelve eccentrics, several connecting rods will participate in torque transfer, permitting a reduction of the cables' thickness. Torque variance transferrable to the driven shaft will not exceed one percent.

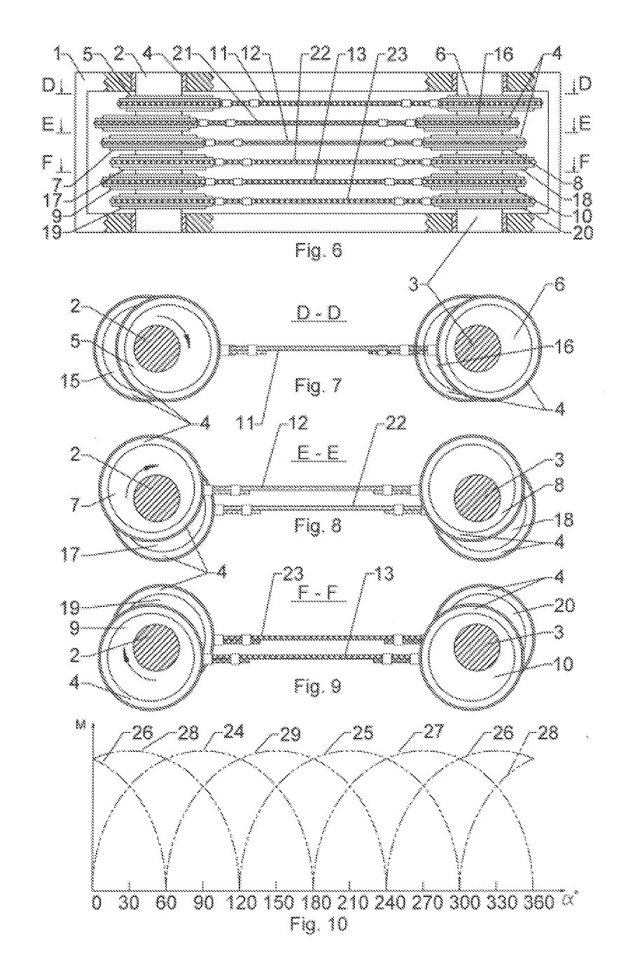

An especially interesting design consists of six to twelve eccentrics positioned in pairs with 180 degree offset from each other. Under this design, inertial forces of the connecting rods and centrifugal forces of the eccentrics will cancel out each other (FIGS. 6,7,8, and 9). The consistency of the transferred torque remains unchanged (FIG. 10) and there is no need for counterweights. In other words, the torque transfer provided by cable-type rods through a corresponding pair of eccentrics is equivalent to the torque transfer provided by a steel connecting rod. The two aramid-fiber cable-type rods permit a 12-fold reduction in weight compared to steel rods.

### BRIEF DESCRIPTION OF DRAWINGS

A device for the transmission of torque via use of three cable-type connecting rods, shown on the drawing (top-down view) in FIG. 1. A cross-section from A-A in FIG. 2. A cross-section from [symbol] in FIG. 3. A cross-section from B-B in FIG. 4. At position 1—power circuit, position 2—driving shaft, position 3—driven shaft, position 4—bearing, positions 5,7,9—eccentrics of the driving shaft, positions 6,8,10—eccentrics of the driven shaft, position 11—cable-type connecting rod between the 5 and 6 eccentrics, position 12—cable-type connecting rod between the 7 and 8 eccentrics, position 13—cable-type connecting rod between the 9 and 10 eccentrics.

A chart of torque variance of the driven shaft in relation to angular rotation of a three cable-type connecting rod setup shown in FIG. 5. At position 24—torque variance during operation of cable-type connecting rod 11, position 25—torque variance during operation of cable-type connecting rod 12, position 26—torque variance during operation of cable-type connecting rod 13.

Device for the transfer of torque using six non-rigid cable-type connecting rods is shown (top-down view) in FIG. 6 (eccentrics and connecting rods positioned analogously to those in FIG. 1 are labeled with the same numbers). Cross-section from Γ-Γ in FIG. 7. Cross-section from [symbol] in FIG. 8. Cross-section from E-E in FIG. 9. At position 15—eccentric rotated 180 degrees to eccentric 5, position 16—eccentric rotated 180 degrees to eccentric 6, position 17—eccentric rotated 180 degrees to eccentric 7, position 18—eccentric rotated 180 degrees to eccentric 8, position 19—eccentric rotated 180 degrees to eccentric 9, position 20—eccentric rotated 180 degrees to eccentric 10, position 21—cable-type connecting rod of eccentrics 15 and 16, position 22—cable-type connecting rod of eccentrics 17 and 18, position 23—cable-type connecting rod of eccentrics 19 and 20.

Chart of torque variance of the driven shaft in relation to angular rotation of a six cable-type connecting rod design shown in FIG. 10. At position 24—torque variance due to cable-type connecting rod 11, position 25—torque variance due to cable-type connecting rod 12, position 26—torque variance due to cable-type connecting rod 13, position 27—torque variance due to cable-type connecting rod 21, position 28—torque variance due to cable-type connecting rod 22, position 29—torque variance due to cable-type connecting rod 23.

### ONE EMBODIMENT OF INVENTION

The simplest variant of an embodiment of this invention would be the use of cable-type connecting rods on a steam locomotive, but due to the low performance index of the locomotive steam engines, steam locomotives are coming out of use. Theoretically, it would be possible to replace the steam engines with free-piston gas generators with performance indexes rivaling ones of the diesel engines, but as of today, usable machines yielding power levels suitable for railroad transportation do not exist. In this case, the need for use of connecting rods made of aramid fibers remains for rail vehicles.

### INDUSTRIAL APPLICABILITY

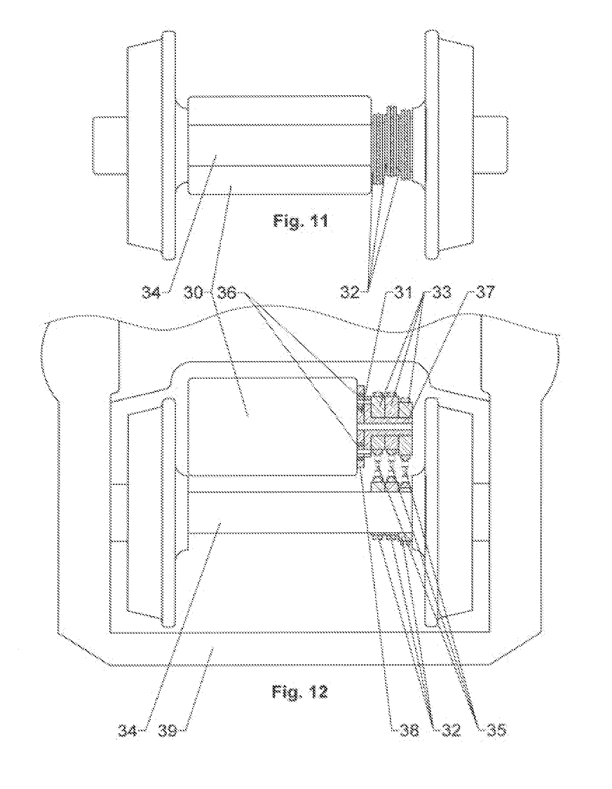

One such need will be observed in the example of the locomotive 2TE116 (Details for the locomotive were obtained from the characteristics provided on the site: http://rustrain.narod.ru/biblio/2te116/soder.htm). Each locomotive section is equipped with a diesel generator, installed on the frame, and six electric motors, transferring torque through gears on the six leading pairs of wheels. The electric motor and the gearbox is connected to the front wheel pair with the help of a supporting-axial chassis, whereby one of the electric motor's supports is resting on the frame, and the second is rigidly connected to the wheel pair. The overall weight of the unsprung part is 4.25 tonnes, which negatively affects the mileage of the electric motor, gearbox, and wheel pair, as well as the lifespan of the railroad track. The alternative is to install the towing electric motor and the gearbox on the frame of the rail car, with a block of six eccentrics installed on the output shaft of the gearbox, and this block by aramid fiber cables is connected to the block of eccentrics installed on the wheel pair. The weight of the unsprung masses in this case equals to the weight of the wheel pair plus the weight of the block of eccentrics installed on its axis, whose weight is around ten kilograms This will positively affect the mileage of the electric motor, gearbox, and wheel pair, as well as the lifespan of the railroad track. When in motion the non-rigid cable-type connecting rods allow the wheel pair to shift slightly relative to the frame (FIGS. 11 and 12).

A possible industrial application of this invention is shown in FIGS. 11 and 12, where the locomotive's wheel pair is rotated by three cable-type connecting rods made of aramid fibers. Position 30—electric motor, position 31—planetary gearbox, position 32—block of eccentrics on the wheel pair axle, position 33—block of eccentrics on the outgoing gearox shaft, position 34—wheel pair, position 35—cable-type connecting rods, position 36—satellites, position 37—output shaft of the gear—carrier, position 38—central wheel, position 39—cart frame.

What is claimed is:

1. A device for the transfer of torque from a driving shaft to a driven shaft, equipped with eccentrics, secured in a quantity not less than three to each of the shafts, and connecting rods, which via bearings connect the eccentrics of the driving and the driven shafts, unique because to permit a greater specific load and weight reduction of the linear moving masses, non-rigid elements—cables, which only operate in tension—are used as flexible connecting rods; eccentrics on each shaft can be mounted at equal intervals, but matching eccentrics can also be offset by up to 50 degrees on each of the shafts, to eliminate any possibility, that vibrations due to connecting rods come in resonance with vibrations of the device itself.

2. Device for the transfer of torque per p.1, unique because in order to improve uniformity of torque transfer to the driven shaft, from four to twelve eccentrics are mounted on each of the shafts.
